(19) United States
(12) Patent Application Publication
(10) Pub. No.: US 2008/0205497 A1
(43) Pub. Date: Aug. 28, 2008

(54) Assembly Comprising a Wireless-Communication Semiconductor Chip

(75) Inventors: Josephus Arnoldus Henricus Maria Kahlman, Eindhoven (NL); Derk Reefman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/916,055

(22) PCT Filed: May 22, 2006
(86) PCT No.: PCT/IB2006/051632

§ 371 Date: Nov. 30, 2007

(30) Foreign Application Priority Data
May 30, 2005 (EP) 05300429.7

(51) Int. Cl. H04B 1/38

(52) U.S. Cl. 375/220

(57) ABSTRACT

A semiconductor chip (CHP) and a semiconductor chip driver (RDR) communicate with each other in a wireless fashion. To that end, the semiconductor chip driver (RDR) generates an energy flux (FX1; FX2) that is concentrated on a transducer area (AT1; AT2) of the semiconductor chip (CHP). In the semiconductor chip (CHP), a wireless communication interlace (WCI) provides an electrical signal to a signal processing circuit in response to the energy flux (FX1; FX2). The signal processing circuit occupies an area (AS) that is substantially separate from the transducer area (AT1; AT2) on which the energy flux (FX1; FX2) is concentrated.

### FIELD OF THE INVENTION

An aspect of the invention relates to an assembly that comprises a semiconductor chip and a semiconductor chip driver, which can communicate with each other in a wireless fashion. The semiconductor chip may comprise, for example, a biosensor circuit for detecting the presence of a particular biological element in a biological substance. Other aspects of the invention relate to a semiconductor chip, a semiconductor chip driver, a method of establishing a wireless communication with a semiconductor chip, a substance analysis system, and a substance analysis cartridge.

### DESCRIPTION OF PRIOR ART

URL “http://www.gpigaming.com/sas_products_rfid.shtml” identifies a web page that relates to RFID chips (URL is an acronym for Uniform Resource Locator; RFID is an acronym for Radio Frequency Identification Device). The web page described the following on 9 May 2005. Readers are necessary to communicate with the RFID chips. The Communication between the RFID chips and the readers is as follows. Triggered by an input instruction, a C.P.U. makes a reader board generate electronic signals that go to a reader antenna to create an electromagnetic field. The embedded antenna of each RFID chip picks up this field and transforms it into energy to activate its integrated circuits. Readers and chips can then exchange information using radio frequency waves. Data (unique serial number, chip value . . . ) can be finally processed or fed in a database. This process provides automatic and 100% accurate accounting of the chips.

### SUMMARY OF THE INVENTION

According to an aspect of the invention, a semiconductor chip and a semiconductor chip driver communicate with each other in a wireless fashion. To that end, the semiconductor chip driver generates an energy flux that is concentrated on a transducer area of the semiconductor chip. In the semiconductor chip, a wireless communication interface provides an electrical signal to a signal processing circuit in response to the energy flux. The signal processing circuit occupies an area that is substantially separate from the transducer area on which the energy flux is concentrated.

The invention takes the following aspects into consideration. A semiconductor chip and a semiconductor chip driver, which can communicate with each other in a wireless fashion, are generally arranged to achieve the following. The semiconductor chip need not be in a particular location in order to communicate with the semiconductor chip driver. The semiconductor chip can communicate with the semiconductor chip driver at any location within a coverage area. RFID systems are arranged in this fashion. In an RFID system, the semiconductor chip driver, which is commonly referred to as reader, generates an electromagnetic field that is distributed throughout the coverage area. A semiconductor chip system picks up the electromagnetic field by means of an antenna, which covers a certain surface. The larger the surface of the antenna, the greater the coverage area is for given electromagnetic field strength.

A semiconductor chip for an RFID system may have an embedded antenna instead of an external antenna. The embedded antenna must be as large as possible so that substantially the entire semiconductor chip surface contributes to converting the electromagnetic field into an electrical signal. That is, substantially the entire semiconductor chip surface must form a transducer area. Otherwise, the coverage area would be too small or the electromagnetic field would have to be unrealistically strong, or even both.

A semiconductor chip and a semiconductor chip driver, which can communicate with each other in a wireless fashion, may be used to advantage in systems other than identification systems, such as RFID systems. For example, such a wireless-communicating chip-and-driver assembly may be used to advantage in a measurement system in which the semiconductor chip comprises a measurement circuit. The semiconductor chip is brought into contact with a substance, which is to be analyzed. Since the semiconductor chip can communicate with the semiconductor chip driver is a wireless fashion, any physical contact between the semiconductor chip driver and the substance, which is to be analyzed, can be avoided. Only the semiconductor chip needs to physically contact the substance, which is to be analyzed. This allows more precise measurement results.

In a measurement system, the wireless-communicating chip-and-driver assembly can be arranged in a fashion similar to identification systems. In that case, the measurement circuit, which is present on the semiconductor chip, will be exposed to the energy field that the semiconductor chip driver generates. The energy field may disturb measurements, which the measurement circuit carries out. This disturbance may be so severe that measurement system provides measurement results that are less precise than those of a measurement system in which there is physical contact between a semiconductor chip, which comprises a measurement circuit, and an external circuit. In that case, the wireless communication does not bring any benefit in terms of more precise measurement results. This is particularly true if the measurement circuit, which is present on the semiconductor chip, processes analog signals of relatively small amplitude, such as, for example, sub-microvolt voltages.

In accordance with the invention, a semiconductor chip driver generates an energy flux that is concentrated on a transducer area of the semiconductor chip. In the semiconductor chip, a wireless communication interface provides an electrical signal to a signal processing circuit in response to the energy flux. The signal processing circuit occupies an area that is substantially separate from the transducer area on which the energy flux is concentrated.

Accordingly, the invention prevents that the energy flux reaches the area that the signal processing circuit occupies on the semiconductor chip. The signal processing circuit is therefore substantially not exposed to the energy flux, by means of which the semiconductor chip and the semiconductor chip driver communicate in a wireless fashion. The energy flux will substantially not interfere with signals that the signal processing circuit processes. These signals may be relatively small. Accordingly, the signal processing circuit can provide precise signal processing results, such as, for example, measurement results. Moreover, the invention provides a galvanic isolation between the signal processing circuit, on the one hand, and an external circuit that cooperates with the signal processing circuit, on the other hand. This further contributes to an interference-free operation. For those reasons, the invention allows relatively precise signal processing results.

Another advantage of the invention relates to the following aspects. Any electrical contact between one and another electrical circuit may corrode and cause a malfunctioning after a certain period of time. Moreover, an electrical contact may be exposed to mechanical stress, which may cause the electrical contact to become faulty after a certain period of time. A bad contact may occur. Since the semiconductor chip and the semiconductor chip driver communicate in a wireless fashion, there is no need for any electrical contacts between the two aforementioned entities. For those reasons, the invention allows relatively high reliability.

These and other aspects of the invention will be described in greater detail hereinafter with reference to drawings.

### BRIEF DESCRIPTION OF THE DRAWINGS

FIG. 1 is a block diagram that illustrates a wireless biosensor.

FIG. 2 is a pictorial diagram that illustrates a semiconductor chip on which the wireless biosensor is implemented.

FIG. 3 is a cross-sectional diagram that illustrates a biosensor system that comprises the semiconductor chip on which the wireless biosensor is implemented.

FIGS. 4A-4C are pictorial diagrams that illustrate a technique for aligning the semiconductor chip within the biosensor system.

### DETAILED DESCRIPTION

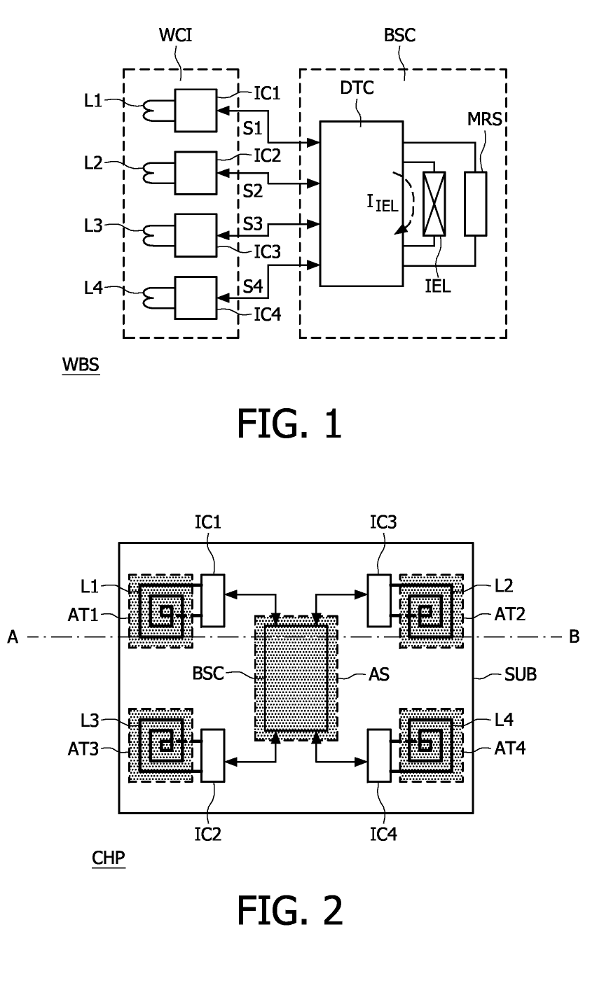

FIG. 1 illustrates a wireless biosensor WBS, which can be implemented on a semiconductor chip. The wireless biosensor WBS comprises a biosensor circuit BSC and a wireless communication interface WCI. The biosensor circuit BSC comprises a detection circuit DTC, an inductive element IEL, and a magnetoresistive sensor MRS. The wireless communication interface WCI comprises four coils L1, L2, L3, L4 and four interface circuits IC1, IC2, IC3, IC4.

The biosensor circuit BSC globally operates as follows. The detection circuit DTC applies a current I_{IEL} to the inductive element IEL. The current I_{IEL}, which flows through the inductive element IEL, produces an electromagnetic field. The electromagnetic field traverses the magnetoresistive sensor MRS. A magnetic particle that is relatively close to the magnetoresistive sensor MRS influences the properties of the electromagnetic field that traverses the magnetoresistive sensor MRS. As a result, the magnetoresistive sensor MRS has an impedance that depends on the presence of magnetic particles, which are relatively close. The magnetoresistive sensor MRS is provided with a binding structure that selectively binds a particular biological element, which is to be detected. The biological element that is to be detected may be, for example, a particular molecule structure, e.g. DNA, proteins, amino-acids or molecules indicating drugs.

A biological substance, which is to be examined, is applied to the biosensor circuit BSC. The biological substance may be, for example, blood or saliva or any other body fluid. The biological element to be detected binds selectively to the surface of the magneto resistive sensor and to magnetic particles. Accordingly, the impedance of the magnetoresistive sensor MRS depends on the presence of the biological element that is to be detected. The detection circuit DTC detects the impedance of the magnetoresistive sensor MRS and, as a consequence, detects the presence of the aforementioned biological element. Further details can be found in patent application number (attorney's docket no. PHNL030949) incorporated by reference herein.

The wireless communication interface WCI allows the biosensor circuit BSC to communicate with an external circuit, which is a circuit that does not form part of the semiconductor chip. Moreover, the biosensor circuit BSC receives a power supply signal via the wireless communication interface WCI.

For example, let it be assumed that coil L1 picks up a relatively strong electromagnetic field. In response thereto, interface circuit IC1 generates an interface signal S1 that comprises a power supply component. To that end, interface circuit IC1 may comprise, for example, a rectifier and a voltage stabilizer. The other interface circuits IC2, IC3, IC4 may be configured in a similar fashion. Accordingly, the other interface circuits IC2, IC3, IC4 provide interface signals S2, S3, S4, respectively, each of which comprises a power supply component.

Any of the aforementioned interface signals S1, S2, S3, S4 may comprise an information signal component. The information signal component may carry information from the external circuit to the biosensor circuit BSC. The information signal component may also carry information in the opposite direction, which is from the biosensor circuit BSC to the external circuit. This will be explained in greater detail hereinafter.

FIG. 2 illustrates the semiconductor chip CHP on which the wireless biosensor WBS is implemented. The semiconductor chip CHP comprises a semiconductor substrate SUB on which the aforementioned elements and circuits of the wireless biosensor WBS are formed. FIG. 2 illustrates that the biosensor circuit BSC is formed in a particular area AS of the semiconductor chip CHP. That is, the biosensor circuit BSC occupies this particular area AS of the semiconductor chip CHP, which will be referred to as biosensor area AS hereinafter.

FIG. 2 further illustrates that coil L1 is formed in a different particular area AT1 of the semiconductor chip CHP, which is separate from the biosensor area AS. The same applies to the other coils L1, L2, L3. That is, the four coils L1, L2, L3, L4 occupy different particular areas AT2, AT3, AT4, respectively, which are separate from each other and separate from the biosensor area AS. These areas AT1, AT2, AT3, AT4 will be referred to as transducer areas, respectively. The four interface circuits IC1, IC2, IC3, IC4, which FIG. 2 illustrates, may be formed in any suitable remaining area. The four interface circuits IC1, IC2, IC3, IC4 may be clustered in a single, common area or may each occupy a different area of the semiconductor chip CHP. FIG. 2 illustrates the latter case.

It should be noted that the transducer areas AT1, AT2, AT3, AT4, on which the four coils L1, L2, L3, L4 are formed, respectively, are similar to bondpad areas of a conventional semiconductor chip CHP. Let it be assumed that transducer area AT1 did not comprise coil L1 but, instead, a bondpad. In that case, the bondpad would have a size that is typical for bondpads of conventional semiconductor chips having a size similar to that of the semiconductor chip CHP, which FIG. 2 illustrates and on which the wireless biosensor WBS is formed. The same applies to the other transducer areas AT2, AT3, AT4. Stated otherwise, each of the four coils L1, L2, L3, L4 has a size that is comparable with a typical bondpad of a conventional semiconductor chip having a size similar to that of the semiconductor chip CHP, which FIG. 2 illustrates.

The four coils L1, L2, L3, L4 on the semiconductor chip CHP are preferably formed of copper. Copper has a low resistivity. Accordingly, there will be relatively little signal loss. Modern integrated circuit manufacturing techniques make it possible to manufacture low-cost semiconductor chips that have a copper layer, in which elements may be formed.

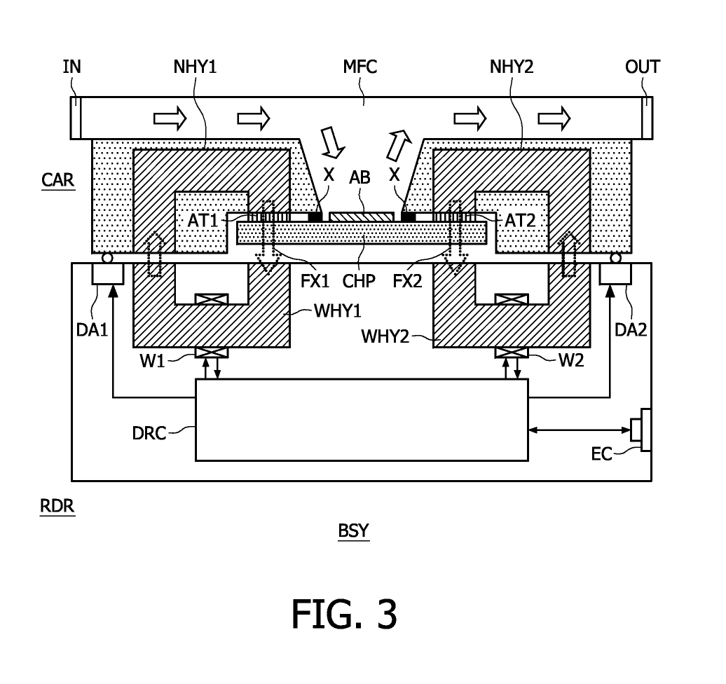

FIG. 3 illustrates a biosensor system BSY in a cross sectional view. The biosensor system BSY comprises a biosensor cartridge CAR and a biosensor reader RDR. An upper portion of FIG. 3 illustrates the biosensor cartridge CAR. A lower portion of FIG. 3 illustrates the biosensor reader RDR. The biosensor cartridge CAR is placed on the biosensor reader RDR and can be removed therefrom so as to place another biosensor cartridge on the biosensor of reader.

The biosensor cartridge CAR comprises a micro fluid channel MFC and various naked half yokes NHY. The micro fluid channel MFC has an inlet IN and an outlet OUT. The biosensor cartridge CAR further comprises the semiconductor chip CHP on which the wireless biosensor WBS, which FIG. 1 illustrates, is formed. FIG. 3 illustrates the semiconductor chip CHP in a cross section along the line A-B in FIG. 2. The semiconductor chip CHP is fixed to the biosensor cartridge CAR by means of glue, which forms a fluid-tight sealing X.

FIG. 3 illustrates two naked half yokes NHY 1, NHY2. Naked half yoke NHY1 has an end surface that faces transducer area AT1 of the semiconductor chip CHP, which coil L1 occupies, as illustrated in FIG. 2. Naked half yoke NHY2 has an end surface that faces transducer area AT2, which coil L2 occupies. FIG. 3 does not show the other transducer areas AT3, AT4 of the semiconductor chip CHP, which FIG. 2 illustrates. However, the biosensor cartridge CAR comprises a naked half yoke for each of these other transducer areas AT3, AT4, although FIG. 3 does not show this.

The biosensor reader RDR comprises a driver-and-reader circuit DRC, various half yokes WHY provided with windings W, various displacement actuators DA, and an external connector EC. FIG. 3 illustrates two half yokes WHY1, WHY2 provided with windings W1, W2, respectively. Half yoke WHY1 is complementary with naked half yoke NHY1 in the biosensor cartridge CAR. Half yoke WHY2 is complementary with naked half yoke NHY2 in the biosensor cartridge CAR.

Half yoke WHY1 comprises an end surface that faces the aforementioned end surface of naked half yoke NHY1. Transducer area AT1 of the semiconductor chip CHP is sandwiched between these respective end surfaces. Likewise, half yoke WHY2 comprises an end surface that faces the aforementioned end surface of naked half yoke NHY2. Transducer area AT2 of the semiconductor chip CHP is sandwiched between these respective end surfaces. The biosensor reader RDR further comprises a half yoke provided with windings for each of the other transducer areas AT3, AT4, which FIG. 2 illustrates. Since FIG. 3 is a cross sectional view along the line A-B in FIG. 2, FIG. 3 does not show these transducer areas and neither shows the half yokes corresponding with these transducer areas.

The naked half yokes NHY of the biosensor cartridge CAR and the half yokes WHY of the biosensor reader RDR are preferably formed of a material that has a high magnetic permeability. The material should preferably introduce little signal loss at the frequencies of interest. Many different ferrite materials exist, each of which provides a satisfactory performance throughout a particular range of frequencies.

The biosensor system BSY operates as follows. The driver-and-reader circuit DRC applies an alternate current to winding W1 on half yoke WHY1. This causes a magnetic flux FX1 to flow through half yoke WHY1 and naked half yoke NHY1. The magnetic flux FX1 traverses transducer area AT1 of the semiconductor chip CHP. As explained hereinbefore, the semiconductor chip CHP can derive a power supply component from the magnetic flux FX1. Moreover, the driver-and-reader circuit DRC can communicate with the semiconductor chip CHP by means of the magnetic flux FX1, which traverses transducer area.

The driver-and-reader circuit DRC may transmit information to the semiconductor chip CHP in the following manner. The driver-and-reader circuit DRC modulates the alternate current that flows through winding W1 with a signal that represents the information to be transmitted. Accordingly, the magnetic flux FX1 will be modulated with the same signal. Coil L1 within transducer area AT1, which FIG. 2 illustrates, picks up the magnetic flux FX1, which is modulated. As a result, interface signal S1, which FIG. 1 illustrates, comprises a modulation component that carries the information, which the driver-and-reader circuit DRC transmits. The biosensor circuit BSC can derive the information from this modulation component.

Conversely, the semiconductor chip CHP may transmit information to the driver-and-reader circuit DRC. As mentioned hereinbefore with reference to FIG. 1, the interface signal S1 may comprise an information signal component that carries information from the biosensor circuit BSC. This information signal component, which originates from the biosensor circuit BSC, may modulate an impedance that is coupled in parallel with coil L1. This impedance modulation will, in its turn, modulate the magnetic flux FX1, which traverses coil L1. In response, windings W1 on half yoke WHY1 will apply a modulation component to the driver-and-reader circuit DRC. The driver-and-reader circuit DRC can derive the information, which originates from the biosensor circuit BSC, from the modulation component that windings W1 on half yoke WHY1 provides.

The driver-and-reader circuit DRC and the semiconductor chip CHP may communicate with each other in similar fashion via transducer area AT2, naked half yoke NHY2, and half yoke WHY2 provided with windings W2. The same applies to the other transducer areas AT3, AT4, which FIG. 2 shows but not FIG. 3. As mentioned hereinbefore, for each of these other transducer areas AT3, AT4, the biosensor system BSY comprises a naked half yoke in the biosensor cartridge CAR and a half yoke with a windings in the biosensor reader RDR. In summary, the semiconductor chip CHP can communicate with the driver-and-reader circuit DRC as if bonding wires connected the semiconductor chip CHP to the driver-and-reader circuit DRC.

A sample of a biological substance, which is applied to the inlet IN, is made to flow through the micro fluid channel MFC and leaves the channel via the outlet OUT. As a result, the sample comes into contact with the biosensor area AS of the semiconductor chip CHP, which the biosensor circuit BSC occupies as illustrated in FIG. 1. The biosensor circuit BSC detects the presence of a particular biological element in the sample in a manner described hereinbefore with reference to FIG. 1. The biological substance, which the biosensor system BSY analyzes, may comprise, for example, blood or saliva as mentioned hereinbefore. The biological element, which is to be detected, may be, for example a particular molecular structure.

The biosensor circuit BSC transmits information, which relates to this detection, to the driver-and-reader circuit DRC by means of the respective magnetic fluxes FX, which the driver-and-reader circuit DRC generates. The driver-and-reader circuit DRC collects and processes this information so as to obtain detection data in a format that allows storage or further processing, if necessary. The driver-and-reader circuit DRC can transmit the detection data to another device via the external connector EC of the biosensor reader RDR.

Once the sample of the biological substance has been made to flow through the micro fluid channel MFC, the biosensor cartridge CAR is contaminated, as it were. The biosensor cartridge CAR should preferably not be subsequently used to analyze any other sample. Since the biosensor cartridge CAR is contaminated, an analysis of another, new sample will most likely produce unreliable results. Therefore, the biosensor cartridge CAR should preferably be disposed once the sample of the biological substance has been made to flow through the micro fluid channel MFC. Alternatively, the biosensor cartridge CAR can be sterilized so that the biosensor cartridge CAR can be used anew. A new, sterile biosensor cartridge can be placed on the biosensor reader RDR, which FIG. 3 illustrates. This allows a reliable analysis of another, new sample of a biological substance.

An important feature of the biosensor system BSY, which FIG. 3 illustrates, is that the biosensor circuit BSC, which is implemented on the semiconductor chip CHP, communicates in a wireless fashion. This avoids contamination of the biosensor reader RDR and any other entity coupled thereto. Avoiding contamination would be difficult if the biosensor circuit BSC were coupled to a driver-and-reader circuit DRC via bondpads and galvanic contacts.

Another important feature is that, although there is a wireless communication between the biosensor circuit BSC and the reader circuit, the wireless communication does not interfere with measurements that the biosensor circuit BSC carries out. The magnetic flux FX1, which the biosensor reader RDR applies to the semiconductor chip CHP, is concentrated on transducer area AT1. The magnetic flux FX1 does not substantially reach the biosensor area AS of the semiconductor chip CHP, which the biosensor circuit BSC occupies. The same applies to the magnetic flux FX2, which the biosensor reader RDR substantially exclusively applies to transducer area AT2 of the semiconductor chip CHP.

The biosensor reader RDR may move the biosensor cartridge CAR to a certain extent by means of the displacement actuators DA. Accordingly, the biosensor reader RDR can align naked half yoke NHY1 with half yoke WHY1 and the other respective naked half yokes NHY with the other respective half yokes WHY that are complementary. This alignment procedure preferably comprises a coarse-alignment phase, which is followed by a fine-alignment phase.

In the coarse-alignment phase, the driver-and-reader circuit DRC may measure an impedance at windings W1 on half yoke WHY1. The impedance that is measured indicates the extent to which the semiconductor chip CHP absorbs the magnetic flux FX1. The driver-and-reader circuit DRC may further measure respective impedances at the respective windings W on the other respective half yokes WHY so as to have an absorption indication which pertains to other respective magnetic fluxes.

The driver-and-reader circuit DRC causes the displacement actuators DA to move the biosensor cartridge CAR on the basis of the respective measured impedances. For example, the driver-and-reader circuit DRC may move the biosensor cartridge CAR on the basis of the following criterion: the respective measured impedances should become as low as possible. The driver-and-reader circuit DRC terminates the coarse alignment phase when the respective measured impedances indicate that there is an overall flux absorption that is sufficiently high to allow a communication between the semiconductor chip CHP and the reader RDR.

In the fine-alignment phase, the semiconductor chip CHP establishes a picked-up power indication. The picked-up power indication indicates respective powers that the respective coils L pick up by reception of respective magnetic fluxes, which the driver-and-reader circuit DRC generates. For example, the four interface circuits IC1, IC2, IC3, IC4, which FIG. 2 illustrates, may each establish and transmit a local picked-up power indication, which pertains to the coil L1, L2, L3, L4, respectively, to which the interface circuit is coupled. In this example, the aforementioned picked-up power indication comprises these respective local picked-up power indications.

The semiconductor chip CHP transmits the picked-up power indication to the driver-and-reader circuit DRC. The driver-and-reader circuit DRC causes the displacement actuators DA to move the biosensor cartridge CAR on the basis of the picked-up power indication that the semiconductor chip CHP provides. Accordingly, a power transfer from the driver-and-reader circuit DRC to the semiconductor chip CHP is optimized and, as a result, and a relatively precise alignment is obtained.

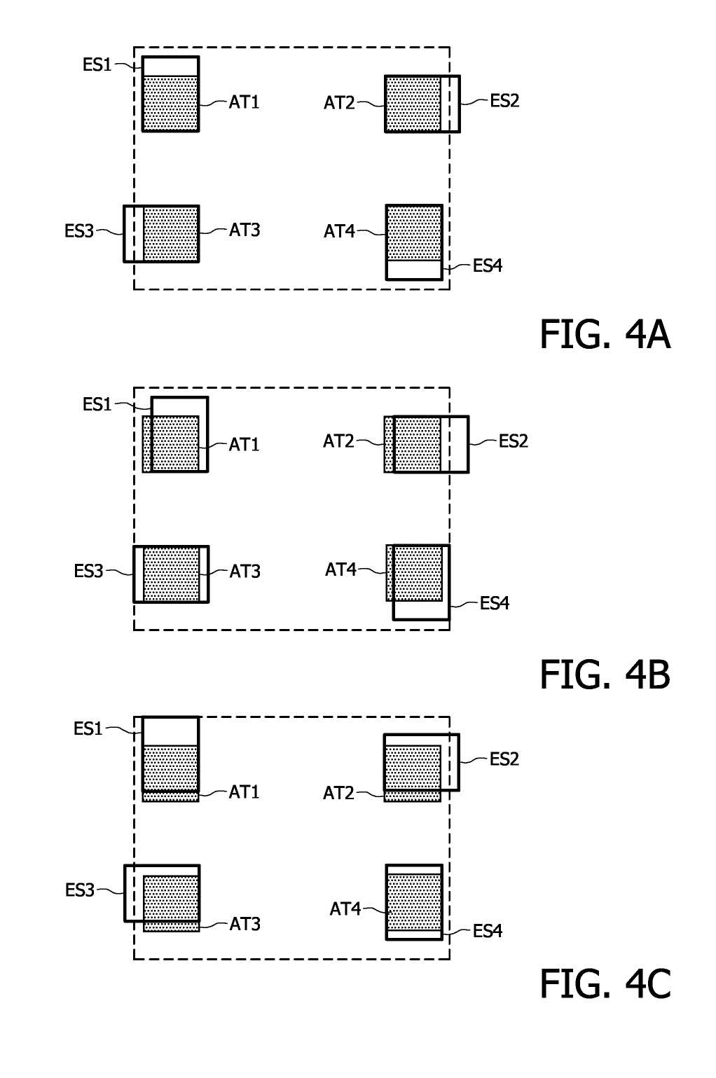

FIGS. 4A-4C illustrate a further technique for aligning the semiconductor chip CHP, which forms part of the biosensor cartridge CAR illustrated in FIG. 3. Each of the FIGS. 4A-4C illustrates the four transducer areas AT1, AT2, AT3, AT4 on the semiconductor chip CHP illustrated in FIG. 3. Furthermore, each of the FIGS. 4A-4C illustrates respective end surfaces ES1, ES2, ES3, ES4 of the respective half yokes WHY that form part of the biosensor reader RDR illustrated in FIG. 3. The end surfaces ES1, ES2, ES3, ES4 are somewhat larger than the transducer areas AT1, AT2, AT3, AT4.

FIG. 4A illustrates a perfect alignment case. The semiconductor chip is perfectly aligned with respect to the half yokes of the biosensor reader. End surface ES1 entirely covers transducer area AT1. Similarly, end surfaces ES2, ES3, ES4 entirely cover transducer areas AT2, AT3, AT4, respectively. In this case, the driver-and-reader circuit will measure substantially identical impedances at each half yoke. It is assumed that the respective windings of the respective half yokes are substantially similar.

FIG. 4A illustrates that the half yokes are designed so that the end surfaces ES1, ES2, ES3, ES4 have the following properties in the perfect alignment case. End surface ES1 somewhat extends beyond transducer area AT1 in an upward vertical direction. Conversely, end surface ES4 somewhat extends beyond transducer area AT4 in a downward vertical direction. End surface ES2 extends beyond transducer area AT2 in a rightward horizontal direction. Conversely, end surface ES3 extends beyond transducer area AT3 in a leftward horizontal direction.

FIG. 4B illustrates a horizontal misalignment case. The semiconductor chip is slightly displaced to the left with respect to the perfect alignment case, which FIG. 4A illustrates. End surface ES1 does not longer entirely cover transducer area AT1. Similarly, end surface ES4 does not longer entirely cover transducer area AT4. However, end surfaces ES1, ES4 cover transducer areas AT1, AT4 to the same extent. As a result, the driver-and-reader circuit will measure substantially similar impedances at the half yoke that has end surface ES1 and the half yoke that has end surface ES4. There is no impedance difference, like in the perfect alignment case.

In contradistinction, the driver-and-reader circuit will measure an impedance difference between the half yoke that has end surface ES2 and the half yoke that has end surface ES3. This is because end surface ES3 still entirely covers transducer area AT3, whereas end surface ES2 does not longer entirely cover transducer area AT2. The impedance at the half yoke having end surface ES2, will be higher than the impedance at the half yoke having end surface ES3. This impedance difference indicates a rightward horizontal displacement with respect to the perfect alignment case.

In general, an impedance difference between the half yoke having end surface ES2 and the half yoke having end surface ES3 indicates a horizontal misalignment. More precisely, such an impedance difference has a sign that indicates the direction of the horizontal misalignment, which may be rightward or leftward. The impedance difference further has an absolute value that indicates the extent of the horizontal misalignment.

FIG. 4C illustrates a vertical misalignment case. The semiconductor chip is slightly displaced downward with respect to the perfect alignment case, which FIG. 4A illustrates. The driver-and-reader circuit will measure an impedance difference between the half yoke that has end surface ES1 and the half yoke that has end surface ES4. This is because end surface ES4 still entirely covers transducer area AT4, whereas end surface ES1 does not longer entirely cover transducer area AT1. The impedance at the half yoke having end surface ES1, will be higher than the impedance at the half yoke having end surface ES4. This impedance difference indicates an upward vertical displacement with respect to the perfect alignment case.

In general, an impedance difference between the half yoke having end surface ES1 and half yoke having end surface ES4, indicates a vertical misalignment. The sign of the impedance difference indicates the direction of the vertical misalignment, which may be upward or downward. The absolute value of the impedance difference indicates the extent of the vertical misalignment.

In FIG. 4C, end surfaces ES2, ES3 cover transducer areas AT2, AT3, respectively, to the same extent. As a result, the driver-and-reader circuit will measure substantially similar impedances at the half yoke that has end surface ES2 and the half yoke that has end surface ES3. There is no impedance difference, like in the perfect alignment case. The absence of such an impedance difference indicates that the semiconductor chip is correctly aligned in the horizontal direction, as explained hereinbefore.

The alignment technique that FIGS. 4A-4C illustrates may also be used in combination with a received power indication instead of an impedance measurement. In such an implementation, the semiconductor chip establishes a picked-up power indication that indicates respective powers that the respective transducer areas AT1, AT2, AT3, AT4 pick up by reception of respective magnetic fluxes. Such an implementation operates in a fashion similar to the fine-alignment phase described hereinbefore.

### CONCLUDING REMARKS

The detailed description hereinbefore with reference to the drawings illustrates the following characteristics, which are cited in various independent claims. A semiconductor chip (CHP) and a semiconductor chip driver (RDR) communicate with each other in a wireless fashion. To that end, the semiconductor chip driver (RDR) generates an energy flux (FX1; FX2) that is concentrated on a transducer area (AT1; AT2) of the semiconductor chip (CHP). In the semiconductor chip (CHP), a wireless communication interface (WCI) provides an electrical signal (S1; S2) to a signal processing circuit (BSC) in response to the energy flux (FX1; FX2). The signal processing circuit (BSC) occupies an area (AS) that is substantially separate from the transducer area (AT1; AT2) on which the energy flux (FX1; FX2) is concentrated.

The detailed description hereinbefore further illustrates various optional characteristics, which are cited in the dependent claims. These characteristics may be applied to advantage in combination with the aforementioned characteristics. Various optional characteristics are highlighted in the following paragraphs. Each paragraph corresponds with a particular dependent claim.

The energy flux (FX1; FX2), which is concentrated on the transducer area (AT1; AT2) of the semiconductor chip (CHP), is a magnetic flux. The wireless communication interface (WCI) of the semiconductor chip (CHP) comprises an on-chip coil (L1; L2), which occupies the transducer area (AT1; AT2). The on-chip coil (L1; L2) provides the electrical signal (S1; S2) to the signal processing circuit (BSC) in response to the magnetic flux (FX1; FX2). These characteristics allow low-cost implementations because an on-chip coil is a relatively low-cost transducer.

The transducer area (AT1; AT2) of the semiconductor chip (CHP) is comparable with an area that a bond pad typically occupies in a conventional semiconductor chip having a size similar to that of the semiconductor chip (CHP). These characteristics contribute to precise signal processing results because the energy flux is concentrated on a relatively small area. Moreover, these characteristics allow low-cost implementations because the semiconductor chip can have a layout comparable with that of conventional semiconductor chips.

The signal processing circuit (BSC) of the semiconductor chip (CHP) comprises a sensor (MRS) for analyzing a substance. The substance is brought into contact with the sensor (MRS) via a supply path. These characteristics allow a precise substance analysis.

The semiconductor chip driver (RDR) comprises a displacement actuator (DA1; DA2) for moving the semiconductor chip (CHP) with respect to the energy flux (FX1; FX2) generator. This characteristic contributes to precise signal processing results because the semiconductor chip (CHP) can be positioned so that the energy flux (FX1; FX2) is efficiently converted into an electrical signal (S1; S2), which obviates a need for a relatively strong energy flux (FX1; FX2).

The semiconductor chip driver (RDR) comprises an absorption detector (DRC) that detects absorption of the energy flux (FX1; FX2) by the wireless communication interface (WCI). The absorption detector (DRC) causes the displacement actuator (DA1; DA2) to move the semiconductor chip (CHP) so as to maximize the absorption. These characteristics allow ease-of-use.

The semiconductor chip (CHP) comprises a picked-up power indicator (IC1; IC2) arranged to establish an indication of a power that the semiconductor chip (CHP) picks up though reception of the energy flux (FX1; FX2). The picked-up power indicator (IC1; IC2) transmits the indication to the semiconductor chip driver (RDR).

The semiconductor chip driver (RDR) comprises a set of energy flux generators (the respective half yokes that have respective end surfaces ES1, ES2, ES3, ES4 illustrated in FIGS. 4A-4C). The energy flux generators generate respective energy fluxes that cover respective transducer areas (AT1, AT2, AT3, AT4) of the semiconductor chip (CHP) to a different extent when the semiconductor chip (CHP) is displaced with respect to a best alignment position (FIGS. 4A-4C illustrate this principle). These characteristics allow accurate alignment of the semiconductor chip in a relatively simple fashion.

The aforementioned characteristics can be implemented in numerous different manners. In order to illustrate this, some alternatives are briefly indicated.

The aforementioned characteristics may be applied to advantage in any type of product or method. A biosensor system is merely an example. The aforementioned characteristics may equally be applied in, for example, a chemical analysis system or any other type of system that can benefit from avoiding physical contact between a semiconductor chip and a semiconductor chip driver. Consequently, the signal processing circuit, which occupies an area that is separate from the transducer area, may be any type of signal processing circuit. A biosensor circuit is merely an example.

The energy flux need not be a magnetic flux. For example, the energy flux may be in the form of a light beam. In such an application, an opto-electrical transducer occupies the transducer area of the semiconductor chip. The opto-electrical transducer may be arranged to modulate the light beam so as to transmit information from the semiconductor chip to the semiconductor chip driver. As another example, it is also possible to establish a power transfer and communication though capacitive coupling. Such an application will generally require relatively large transducer areas so as to avoid use of relatively high voltages, which may cause disruptive discharges. It should further be noted that an application may use various types of energy fluxes, such as, for example, a combination of a magnetic flux and a light beam.

The semiconductor chip may comprise any number of transducer areas. The semiconductor chip that FIG. 2 illustrates, which comprises 4 transducer areas, is merely an example. The semiconductor chip may comprise, for example, a single transducer area. In such an implementation, different types of information can be exchanged simultaneously through multiplexing.

It should also be noted that a transducer, which occupies the transducer area, may be formed on a bottom side of the semiconductor chip, whereas the signal processing circuit is formed on a top side. In such an implementation, the semiconductor chip may be provided with conductive through holes that the couple the transducer to the signal processing circuit.

The semiconductor chip need not form part of any cartridge, even in a biosensor implementation. For example, the semiconductor chip may be pressed against a chamber that has an opening so that a sensor on the semiconductor chip faces this opening. The semiconductor chip may be disposed of when an analysis has been completed. The chamber is reutilized, preferably after a cleaning thereof. The semiconductor chip, which is relatively cheap, may be the only disposable element in such an implementation.

Referring to FIG. 4A-4C, the end surfaces ES1, ES2, ES3, ES4 may have numerous different other shapes and dimensions. For example, each end surface may be made somewhat narrower so that the respective end surfaces cover only a portion of the respective transducer areas AT1, AT2, AT3, AT4 in the perfect alignment case, which FIG. 4A illustrates. As another example, the end surfaces ES1, ES2, ES3, ES4 may be shifted in a left-and-upward direction, a right-and-upward direction, a left-and-downward direction, and a right-and-downward direction, respectively. The end surfaces will then only partially cover the transducer areas AT1, AT2, AT3, AT4 in the perfect alignment case. There will be an equal power transfer for all transducers areas, which, however, will not be maximal for any given transducer area. All what matters is that a displacement differently affects respective coverages of the respective transducer areas by the respective end surfaces. This is sufficient to establish the direction and the sign of any misalignment.

The term “communicate” should be understood in a broad sense. The term may include a transfer of power from the semiconductor chip driver to the semiconductor chip.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description with reference to the drawings, illustrate rather than limit the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. An assembly comprising a semiconductor chip (CHP) and a semiconductor chip driver (RDR), which can communicate with each other in a wireless fashion,
the semiconductor chip driver (RDR) comprising:
an energy flux generator (DRC, WHY1, W1, WHY2, W2) arranged to generate an energy flux (FX1; FX2) that is concentrated on a transducer area (AT1; AT2) of the semiconductor chip (CHP),
the semiconductor chip (CHP) comprising:
a signal processing circuit (BSC) that occupies an area (AS) of the semiconductor chip (CHP), which area (AS) is substantially separate from the transducer area (AT1; AT2); and
a wireless communication interface (WCI) arranged to provide an electrical signal (S1; S2) to the signal processing circuit (BSC) in response to the energy flux (FX1; FX2), which is concentrated on the transducer area (AT1; AT2).

2. An assembly as claimed in claim 1, the energy flux generator (DRC, WHY1, W1, WHY2, W2) being arranged to generate a magnetic flux (FX1; FX2) that is concentrated on the transducer area (AT1; AT2) of the semiconductor chip (CHP), the wireless communication interface (WCI) of the semiconductor chip (CHP) comprising an on-chip coil (L1; L2), which occupies the transducer area (AT1; AT2), for providing the electrical signal (S1; S2) to the signal processing circuit (BSC) in response to the magnetic flux (FX1; FX2).

3. An assembly as claimed in claim 1, the transducer area (AT1; AT2) of the semiconductor chip (CHP) being comparable with an area (AS) that a bond pad typically occupies in a conventional semiconductor chip (CHP) having a size that similar to that of the semiconductor chip (CHP).

4. An assembly as claimed in claim 1, the signal processing circuit (BSC) of the semiconductor chip (CHP) comprising a sensor (MRS) for analyzing a substance, the assembly comprising a supply path via which the substance can be brought into contact with the sensor (MRS).

5. An assembly as claimed in claim 1, the semiconductor chip driver (RDR) comprising a displacement actuator (DA1; DA2) for moving the semiconductor chip (CHP) with respect to the energy flux generator (DRC, WHY1, W1, WHY2, W2).

6. An assembly as claimed in claim 5, the semiconductor chip driver (RDR) comprising an absorption detector (DRC) arranged to detect absorption of the energy flux (FX1; FX2) by the wireless communication interface (WCI) and being arranged to cause the displacement actuator (DA1; DA2) to move the semiconductor chip (CHP) so as to maximize the absorption.

7. An assembly as claimed in claim 5, the semiconductor chip (CHP) comprising a picked-up power indicator (IC1; IC2) arranged to establish an indication of a power that the semiconductor chip (CHP) picks up though reception of the energy flux (FX1; FX2) and being arranged to transmit the indication to the semiconductor chip driver (RDR).

8. An assembly as claimed in claim 5, the semiconductor chip driver (RDR) comprising a set of energy flux generators arranged to generate respective energy fluxes that cover respective transducer areas (AT1, AT2, AT3, AT4) of the semiconductor chip (CHP) to a different extent when the semiconductor chip (CHP) is displaced with respect to a best alignment position.

9. A semiconductor chip (CHP) which can communicate in a wireless fashion with a semiconductor chip driver (RDR) that comprises an energy flux generator (DRC, WHY1, W1, WHY2, W2) arranged to generate an energy flux (FX1; FX2) that is concentrated on a transducer area (AT1; AT2) of the semiconductor chip (CHP),
the semiconductor chip (CHP) comprising:
a signal processing circuit (BSC) that occupies an area (AS) of the semiconductor chip (CHP), which area (AS) is substantially separate from the transducer area (AT1; AT2); and
a wireless communication interface (WCI) arranged to provide an electrical signal (S1; S2) to the signal processing circuit (BSC) in response to the energy flux (FX1; FX2) from the semiconductor chip driver (DR), which is concentrated on the transducer area (AT1; AT2).

10. A semiconductor chip driver (RDR), which can communicate in a wireless fashion with a semiconductor chip (CHP) that comprises:
a signal processing circuit (BSC), which occupies an area (AS) of the semiconductor chip (CHP); and
a wireless communication interface (WCI) arranged to provide an electrical signal (S1; S2) to the signal processing circuit (BSC) in response to an energy flux (FX1; FX2) that hits a transducer area (AT1; AT2) of the semiconductor chip (CHP), the transducer area (AT1; AT2) being substantially separate from the area (AS) that the signal processing circuit (BSC) occupies,
the semiconductor chip driver (RDR) comprising:
an energy flux generator (DRC, WHY1, W1, WHY2, W2) arranged to generate an energy flux (FX1; FX2) that is concentrated on the transducer area (AT1; AT2) of the semiconductor chip (CHP).

11. A method of establishing a wireless communication with a semiconductor chip (CHP) that comprises:
a signal processing circuit (BSC), which occupies an area (AS) of the semiconductor chip (CHP); and
a wireless communication interface (WCI) arranged to provide an electrical signal (S1; S2) to the signal processing circuit (BSC) in response to an energy flux (FX1; FX2) that hits a transducer area (AT1; AT2) of the semiconductor chip (CHP), the transducer area (AT1; AT2) being substantially separate from the area (AS) that the signal processing circuit (BSC) occupies,
the method comprising:
an energy flux generation step in which an energy flux (FX1; FX2) is generated that is concentrated on the transducer area (AT1; AT2) of the semiconductor chip (CHP).

12. A substance analysis system (BSY) comprising a substance analysis cartridge (CAR) and a substance analysis reader (RDR), which can communicate with each other in a wireless fashion,
the substance analysis cartridge (CAR) comprising:
a semiconductor chip (CHP) comprising a sensor (MRS) for analyzing a substance, the sensor (MRS) occupying an area (AS) of the semiconductor chip (CHP), the semiconductor chip (CHP) further comprising a wireless communication interface (WCI) arranged to provide an electrical signal (S1; S2) to the signal processing circuit (BSC) in response to an energy flux (FX1; FX2) that hits a transducer area (AT1; AT2) of the semiconductor chip (CHP), the transducer area (AT1; AT2) being substantially separate from the area (AS) that the signal processing circuit (BSC) occupies; and
a supply path (MFC) via which the substance can be brought into contact with the sensor (MRS) on the semiconductor chip (CHP),
the substance analysis reader (RDR) comprising:
an energy flux generator (DRC, WHY1, W1, WHY2, W2) arranged to generate an energy flux (FX1; FX2) that is concentrated on the transducer area (AT1; AT2) of the semiconductor chip (CHP).

13. A substance analysis cartridge (CAR) comprising:
a semiconductor chip (CHP) comprising a sensor (MRS) for analyzing a substance, the sensor (MRS) occupying an area (AS) of the semiconductor chip (CHP), the semiconductor chip (CHP) further comprising a wireless communication interface (WCI) arranged to provide an electrical signal (S1; S2) to the signal processing circuit (BSC) in response to an energy flux (FX1; FX2) that hits a transducer area (AT1; AT2) of the semiconductor chip (CHP), the transducer area (AT1; AT2) being substantially separate from the area (AS) that the signal processing circuit (BSC) occupies; and
a supply path via (MFC) which the substance can be brought into contact with the sensor (MRS) on the semiconductor chip (CHP).
